(19) United States
(12) Patent Application Publication
(10) Pub. No.: US 2022/0276703 A1
(43) Pub. Date: Sep. 1, 2022

(54) APPARATUS AND METHOD FOR NORMALIZING START OF EYE TRACKING FOR ANALYZING USER'S SCREEN CONCENTRATION LEVEL

(71) Applicant: BLAUBIT CO., LTD., Seongnam-si (KR)

(72) Inventor: Euisun KIM, Seoul (KR)

(73) Assignee: BLAUBIT CO., LTD., Seongnam-si (KR)

(21) Appl. No.: 17/547,899

(22) Filed: Dec. 10, 2021

(30) Foreign Application Priority Data
Feb. 26, 2021 (KR) 10-2021-0026334

(51) Int. Cl. G06F 3/01; G06T 7/246

(52) U.S. Cl. CPC G06F 3/013; G06T 7/246; G06T 2207/30201; G06T 2207/20084

(57) ABSTRACT

Disclosed are an apparatus and method for normalizing the start of eye tracking for analyzing a user's screen concentration level. The present disclosure can increase reliability of the results of the analysis of a user's screen concentration level by normalizing timing at which a user's eye is tracked during a service for analyzing the screen concentration level.

### CROSS-REFERENCE TO RELATED APPLICATIONS

This application claims priority from and the benefit of Korean Patent Application No. 10-2021-0026334 , filed on Feb. 26, 2021, which is hereby incorporated by reference for all purposes as if set forth herein.

### BACKGROUND

### 1. Technical Field

The present disclosure relates to an apparatus and method for normalizing the start of eye tracking for analyzing a user's screen concentration level, and more particularly, to an apparatus and method for normalizing the start of eye tracking for analyzing a user's screen concentration level, which increase reliability of the results of the analysis of a user's screen concentration level by normalizing timing at which a user's eye is tracked during a service for analyzing the concentration level.

### 2. Related Art

Eye tracking is a technology for tracking a location of a gaze of a user by detecting the user's eyeball movement. A method, such as an image analysis method, a contact lens method, or a sensor attachment method, may be used for eye tracking.

In the image analysis method, a movement of the pupil of a user is detected by analyzing a camera image in real time, and the direction of a gaze of the user is calculated based on a fixed location reflected in the cornea of the user. In the contact lens method, reflected light of a mirror-embedded contact lens, a magnetic field of a coil-embedded contact lens, etc. is used. The contact lens method has low convenience, but has high accuracy.

In the sensor attachment method, a sensor is attached around an eye of a user, and a movement of an eyeball of the user is detected based on a change in the electric field according to a movement of the eye. A movement of the eyeball can be detected although the user closes his or her eye (e.g., while sleeping).

Recently, target devices and fields to which the eye tracking technology is applied are gradually expanded. Accordingly, attempts to use such an eye tracking technology in collecting data, such as a preferred product or service, by tracking gazes of people are increasing.

For example, upon learning using video such as video lecture, a learning effect may be calculated by analyzing a user's concentration level using eye tracking.

However, in a process of analyzing a user's concentration level by tracking a gaze of the user, it is difficult to determine timing at which eye tracking will be tracked. Accordingly, there is a problem in that reliability of the results of the analysis of a concentration level is lowered.

[Prior Art Document] Korean Patent Application Publication No. 10-2019-0118965 (Title of the Invention: System and method for eye-tracking)

### SUMMARY

Various embodiments are directed to providing an apparatus and method for normalizing the start of eye tracking for analyzing a user's screen concentration level, which increase reliability of the results of the analysis of a user's screen concentration level by normalizing timing at which a user's eye is tracked during a service for analyzing the screen concentration level.

In an embodiment, an apparatus for normalizing the start of eye tracking for analyzing a user's screen concentration level may include a measuring terminal configured to detect the pupil in a captured image, track a gaze of the detected pupil, and measure a response time of the pupil for which the pupil gazes at in response to a tracking start indication marker displayed based on a tracking start index, and a server configured to transmit content information, a tracking start index, and content information to the measuring terminal and generate a tracking start index by incorporating, into the tracking start index, eye tracking information of the pupil and the response time of the pupil received from the measuring terminal.

Furthermore, the tracking start indication marker according to the embodiment is displayed at any one of a specific location or a random location on a screen of the measuring terminal.

Furthermore, the server according to the embodiment normalizes and analyzes the response time of the pupil according to the location where the tracking start indication marker is displayed by using an artificial intelligence model and incorporates results of the normalization and analysis into the tracking start index.

Furthermore, the server according to the embodiment analyzes a display location of an optimum tracking start indication marker at which the pupil gazes by using the artificial intelligence model.

Furthermore, the measuring terminal according to the embodiment includes a data communication unit configured to transmit and receive the content information, the tracking start index, the eye tracking information of the pupil, and the response time of the pupil to and from the server, a camera unit configured to output the captured image including the pupil, a display unit configured to display the content information and the tracking start indication marker, and a terminal controller configured to detect the pupil in the captured image, obtain the eye tracking information of the detected pupil, display the tracking start indication marker based on the content information and the tracking start index, and measure the response time of the pupil for which the pupil gazes at in response to the tracking start indication marker.

Furthermore, the server according to the embodiment includes a data communication unit configured to transmit and receive the content information, the tracking start index, the eye tracking information of the pupil and the response time of the pupil to and from the measuring terminal, a content provision unit configured to provide given content information to the measuring terminal, the pupil tracking unit configured to receive the eye tracking information of the pupil and the response time of the pupil for which the pupil gazes at in response to the tracking start indication marker from the measuring terminal and analyze the eye tracking information and the response time, an artificial intelligence (AI) learning unit configured to normalize and analyze the response time of the pupil according to a location where the tracking start indication marker is displayed by using an artificial intelligence model and learn calculation of a display location of an optimum tracking start indication marker at which the pupil gazes, and a data storage unit configured to store the content information, the tracking start index, the eye tracking information of the pupil, and the response time of the pupil.

Furthermore, the artificial intelligence model according to the embodiment learns a display location of an optimum tracking start indication marker at which the pupil gazes based on learning data, including the eye tracking information of the pupil and the response time of the pupil according to a location where the tracking start indication marker is displayed by using a convolutional neural network (CNN)-based deep learning model.

Furthermore, the pupil tracking unit according to the embodiment includes a tracking start sensing unit configured to detect the tracking start indication marker, and the pupil response analysis unit configured to analyze the response time for which the pupil gazes at in response to the tracking start indication marker displayed based on the eye tracking information of the pupil.

Furthermore, the pupil tracking unit according to the embodiment further includes a concentration level analysis unit 233 configured to analyze a concentration level by analyzing the eye tracking information of the pupil after the response time of the pupil.

Furthermore, in an embodiment, a method of normalizing the start of eye tracking for analyzing a user's screen concentration level includes steps of a) when a server authenticates login information of a measuring terminal, displaying given content information through the measuring terminal, b) detecting, by the measuring terminal, the pupil in a captured image, tracking a gaze of the pupil, displaying a tracking start indication marker based on a tracking start index, and detecting a response of the pupil, c) as the response of the pupil is detected, storing, by the measuring terminal, eye tracking information of the pupil, a display location of the tracking start indication marker and a response time of the pupil, and d) analyzing, by the server, a display location of an optimum tracking start indication marker at which the pupil gazes based on the eye tracking information of the pupil, the display location of the tracking start indication marker, and the response time of the pupil measured by the measuring terminal and generating a tracking start index by incorporating results of the analysis into the tracking start index.

Furthermore, the tracking start indication marker in the step b) according to the embodiment is displayed at any one of a specific location or a random location on a display unit of the measuring terminal.

Furthermore, the step d) according to the embodiment includes analyzing, by the server, the display location of the optimum tracking start indication marker at which the pupil gazes by using an artificial intelligence model.

Furthermore, the artificial intelligence model learns a display location of an optimum tracking start indication marker at which the pupil gazes based on learning data, including the eye tracking information of the pupil and the response time of the pupil according to a location where the tracking start indication marker is displayed by using a convolutional neural network (CNN)-based deep learning model.

The present disclosure has an advantage in that it can increase reliability of the results of the analysis of a user's screen concentration level by normalizing timing at which a user's eye is tracked during a service for analyzing the screen concentration level.

### BRIEF DESCRIPTION OF THE DRAWINGS

FIG. 1 is an exemplary diagram schematically illustrating a configuration of an apparatus for normalizing the start of eye tracking for analyzing a user's screen concentration level according to an embodiment of the present disclosure.

FIG. 2 is a block diagram illustrating a configuration of a terminal of the apparatus for normalizing the start of eye tracking for analyzing a user's screen concentration level according to the embodiment of FIG. 1.

FIG. 3 is a block diagram illustrating a configuration of a server of the apparatus for normalizing the start of eye tracking for analyzing a user's screen concentration level according to the embodiment of FIG. 1.

FIG. 4 is a block diagram illustrating a configuration of a pupil tracking unit of the server according to the embodiment of FIG. 3.

FIG. 5 is an exemplary diagram illustrating the state in which tracking timing of the apparatus for normalizing the start of eye tracking for analyzing a user's screen concentration level according to the embodiment of FIG. 1 is displayed on a screen.

FIG. 6 is a flowchart illustrated to describe a method of normalizing the start of eye tracking for analyzing a user's screen concentration level according to an embodiment of the present disclosure.

### DETAILED DESCRIPTION

Hereinafter, embodiments of the present disclosure are described in detail with reference to the accompanying drawings, but it is presupposed that the same reference numerals denote the same elements.

Prior to a description of detailed contents for implementing the present disclosure, it is to be noted that an element not directly related to a technical subject matter of the present disclosure is omitted without making the subject matter unnecessarily vague.

Furthermore, the terms or words used in this specification and the claims should be interpreted as meanings and concepts which comply with the technical spirit of an invention based on the principle that an inventor may define the concept of a proper term in order to describe his or her invention in the best manner.

In the specification, when it is described that any part “includes” any element, this means that the any part may further include another element without excluding another element.

Furthermore, the term “ . . . unit”, “ . . . er (or or), “ . . . module”, etc., means a unit for processing at least one function or operation, and the unit, the module, etc. may be implemented by hardware or software or a combination of hardware and software

Furthermore, a term “at least one” is defined as a term including the singular and the plural. It is evident that although the term “at least one” is not present, each element may be present as the singular or the plural and may mean the singular or the plural.

Furthermore, each element provided as the singular or the plural may be changed according to an embodiment.

Hereinafter, an apparatus and method for normalizing the start of eye tracking for analyzing a user's screen concentration level according to an embodiment of the present disclosure are described in detail below with reference to the accompanying drawings.

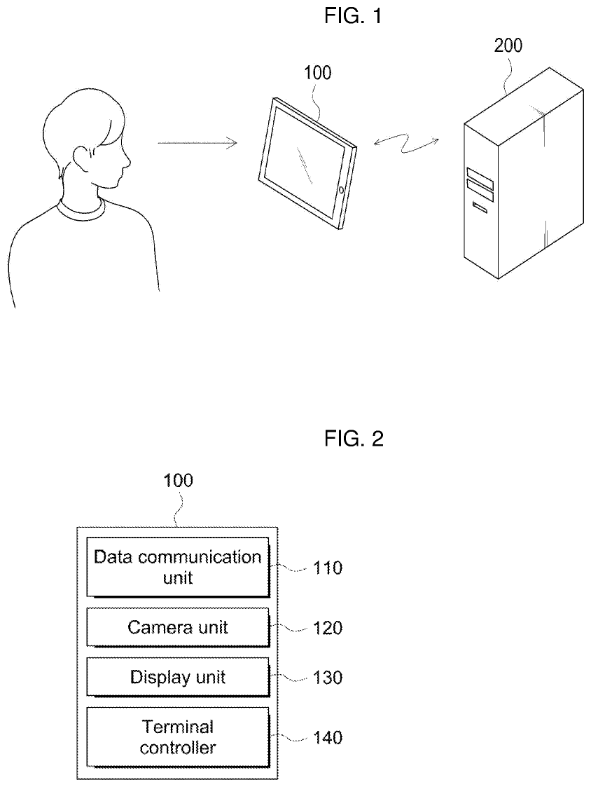

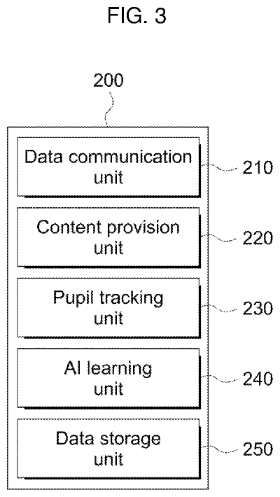

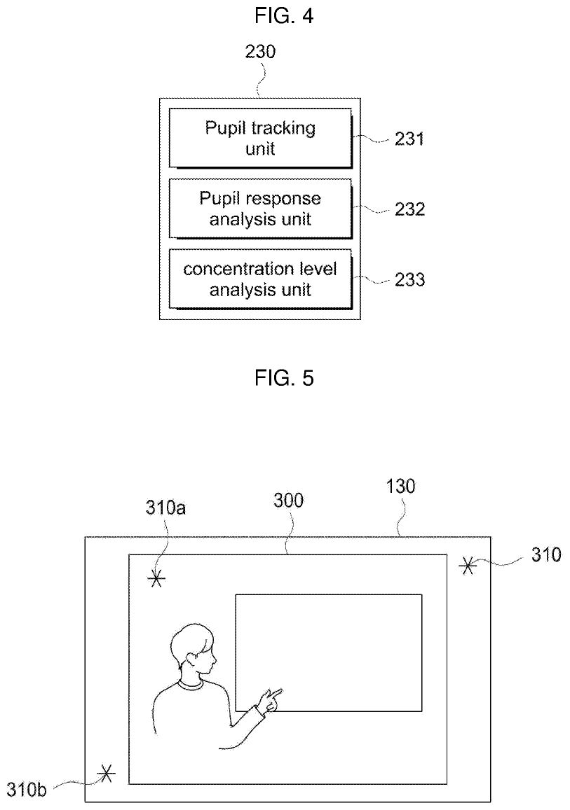

FIG. 1 is an exemplary diagram schematically illustrating a configuration of an apparatus for normalizing the start of eye tracking for analyzing a user's screen concentration level according to an embodiment of the present disclosure. FIG. 2 is a block diagram illustrating a configuration of a terminal of the apparatus for normalizing the start of eye tracking for analyzing a user's screen concentration level according to the embodiment of FIG. 1. FIG. 3 is a block diagram illustrating a configuration of a server of the apparatus for normalizing the start of eye tracking for analyzing a user's screen concentration level according to the embodiment of FIG. 1. FIG. 4 is a block diagram illustrating a configuration of a pupil tracking unit of the server according to the embodiment of FIG. 3. FIG. 5 is an exemplary diagram illustrating the state in which tracking timing of the apparatus for normalizing the start of eye tracking for analyzing a user's screen concentration level according to the embodiment of FIG. 1 is displayed on a screen.

Referring to FIGS. 1 to 5, the apparatus for normalizing the start of eye tracking for analyzing a user's screen concentration level according to an embodiment of the present disclosure may be configured to include a measuring terminal 100 and a server 200.

The measuring terminal 100 is connected to the server 200 over a network, and is an element for detecting the pupil of an eye in a captured image, tracking a gaze of the detected pupil, and measuring a response time of the pupil for which the pupil gazes at in response to a tracking start indication marker 310, 310a or 310b displayed based on a tracking start index. The measuring terminal 100 may be configured to include a data communication unit 110, a camera unit 120, a display unit 130, and a terminal controller 140.

Furthermore, the measuring terminal 100 is a wireless communication device, and may include all types of handheld-based wireless communication devices, such as a device for navigation, a personal communication system (PCS), a Global System for Mobile communications (GSM), a personal digital cellular (PDC), a personal handyphone system (PHS), a personal digital assistant (PDA), International Mobile Telecommunication (IMT)-2000, code division multiple access (CDMA)-2000, W-code division multiple access (W-CDMA), a wireless broadband Internet (Wibro) terminal, a smartphone, a smartpad, and a tablet PC.

In the present embodiment, a smartphone in which an application program can be installed is described as an embodiment for convenience of description, but the present disclosure is not limited thereto.

Furthermore, the network means a connection structure through which nodes, such as a plurality of terminals and servers can exchange information. Examples of such a network include an RF, a 3rd Generation Partnership Project (3GPP) network, a long term revolution (LTE) network, a 5^{th} Generation Partnership Project (5GPP) network, a World Interoperability for Microwave Access (WIMAX) network, the Internet, a local area network (LAN), a wireless LAN, a wide area network (WAN), a personal area network (PAN), a Bluetooth network, an NFC network, a satellite broadcasting network, an analog broadcasting network, a digital multimedia broadcasting (DMB) network, etc., but the present disclosure is not limited thereto.

The data communication unit 110 transmits and receives content information, a tracking start index, content information, eye tracking information of the pupil of an eye, and a response time of the pupil to and from the server 200.

The camera unit 120 is an element for outputting a captured image, including the pupil of an eye, and may be photographing means consisting of a CCD sensor, a CMOS sensor or a given photoelectric transformation sensor.

The display unit 130 is an element for displaying content information and the tracking start indication marker 310, 310a or 310b transmitted by the server 200, and may be composed of a display panel, such as an LCD or an LED.

The terminal controller 140 detects the pupil in an image captured through the camera unit 120 and obtains eye tracking information of the detected pupil.

Furthermore, the terminal controller 140 controls content information to be played back through the display unit 130 based on content information received from the server 200.

Furthermore, the terminal controller 140 controls the tracking start indication marker 310, 310a or 310b to be displayed on the display unit 130 based on a tracking start index received from the server 200.

The tracking start indication marker 310, 310a or 310b may be displayed at any one of a specific location or a random location on a screen of the display unit 130.

Furthermore, while performing eye tracking on the pupil, the terminal controller 140 displays the tracking start indication marker 310, 310a or 310b, and then measures a response time of the pupil for which the pupil gazes at in response to the display of the tracking start indication marker 310, 310a or 310b.

Furthermore, after storing the measured response time of the pupil and eye tracking information of the pupil, the terminal controller 140 controls the measured response time of the pupil and the eye tracking information to be transmitted to the server 200 through the data communication unit 110.

The server 200 is an element for transmitting content information, a tracking start index, and content information to the measuring terminal 100 connected thereto over a network and generating a tracking start index by incorporating eye tracking information of the pupil and a response time of the pupil received from the measuring terminal 100 into the tracking start index. The server 200 may be configured to include a data communication unit 210, a content provision unit 220, a pupil tracking unit 230, an artificial intelligence (AI) learning unit 240, and a data storage unit 250.

Furthermore, the server 200 may normalize and analyze a response time of the pupil according to a location where the tracking start indication marker 310, 310a or 310b is displayed by using an artificial intelligence (AI) model, and may store the results of the normalization and analysis by incorporating the results of the normalization and analysis into a tracking start index.

Furthermore, the server 200 may analyze a display location of an optimum tracking start indication marker 310, 310a or 310b at which the pupil gazes by using the AI model.

The data communication unit 210 transmits and receives content information, a tracking start index, content information, eye tracking information of the pupil, and a response time of the pupil to and from the measuring terminal 100.

The content provision unit 220 provides the measuring terminal 100 with given content information, for example, video information.

The pupil tracking unit 230 is an element for receiving, from the measuring terminal 100, eye tracking information of the pupil and a response time of the pupil for which the pupil gazes at in response to the tracking start indication marker 310, 310a or 310b and analyzing the received eye tracking information and response time. The pupil tracking unit 230 may be configured to include a tracking start sensing unit 231, a pupil response analysis unit 232, and a concentration level analysis unit 233.

The tracking start sensing unit 231 detects eye tracking information of the pupil received from the measuring terminal 100, the tracking start indication marker 310, 310a or 310b, and information on a display location of the tracking start indication marker 310, 310a or 310b.

The pupil response analysis unit 232 analyzes a response time for which the pupil gazes at in response to the tracking start indication marker 310, 310a or 310b displayed based on eye tracking information of the pupil received from the measuring terminal 100.

The concentration level analysis unit 233 analyzes a concentration level according to an area where the pupil gazes at by analyzing eye tracking information of the pupil after a response time of the pupil.

That is, after the time when the pupil responds to the tracking start indication marker 310, 310a or 310b, the concentration level analysis unit 233 may calculate a concentration level by analyzing a gaze point at which the pupil is fixed to a specific gaze area and a gaze of the pupil is maintained and the time for which the gaze is maintained.

The AI learning unit 240 normalizes and analyzes a response time of the pupil according to a location where the tracking start indication marker 310, 310a or 310b is displayed by using the AI model.

Furthermore, the AI learning unit 240 learns the analysis of a display location of an optimum tracking start indication marker 310, 310a or 310b at which the pupil gazes.

That is, the AI learning unit 240 learns a display location of an optimum tracking start indication marker 310, 310a or 310b at which the pupil gazes on the display unit 130 by using, as learning data, eye tracking information of the pupil and a response time of the pupil according to a location where the tracking start indication marker 310, 310a or 310b is displayed.

In this case, in the optimum tracking start indication marker 310, 310a or 310b, a direction toward which a gaze of a user is directed and the time when the pupil responds are different depending on the user. Accordingly, the AI learning unit 240 performs normalization and analysis by learning a different location where the tracking start indication marker 310, 310a or 310b is displayed and the time and period in which the tracking start indication marker 310, 310a or 310b is displayed by using the AI model, and incorporates the results of the learning into a tracking start index.

Furthermore, the AI model learns a display location of an optimum tracking start indication marker 310, 310a or 310b at which the pupil gazes and a display time for which the pupil gazes at based on learning data, including eye tracking information of the pupil and a response time of the pupil according to a location where the tracking start indication marker 310, 310a or 310b is displayed, by using a convolutional neural network (CNN)-based deep learning model.

The data storage unit 250 stores content information, a tracking start index, eye tracking information of the pupil, a response time of the pupil, the AI model, etc.

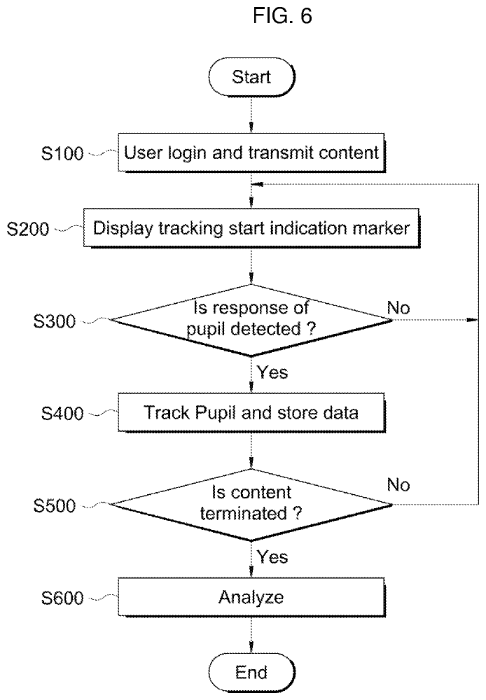

A method of normalizing the start of eye tracking for analyzing a user's screen concentration level according to an embodiment of the present disclosure is described with reference to FIGS. 1 to 6.

As described above with reference to FIGS. 1 to 6, when the server 200 authenticates login information of the measuring terminal 100 connected thereto over a network, the server 200 transmits a tracking start index and given content information to the measuring terminal 100 (S100).

The measuring terminal 100 displays the content information in step S100 on the display unit 130, detects the pupil in an image captured by the camera unit 120, tracks a gaze of the pupil, displays the tracking start indication marker 310, 310a or 310b (S200) based on the tracking start index received in step S100, and detects a response of the pupil (S300) according to the display of the tracking start indication marker 310, 310a or 310b.

In this case, the tracking start indication marker 310, 310a or 310b displayed in step S200 may be displayed at any one of a specific location or a random location on the display unit 130 of the measuring terminal 100.

Next, as the response of the pupil is detected, the measuring terminal 100 stores eye tracking information of the pupil, the display location of the tracking start indication marker 310, 310a or 310b, and the response time of the pupil (S400).

Furthermore, the eye tracking information of the pupil, the display location of the tracking start indication marker 310, 310a or 310b and the response time of the pupil stored in step S400 are transmitted to the server 200. Whether the playback of content being displayed is terminated may be determined (S500). Steps S200 to S400 may be repeatedly performed until the content is terminated.

The server 200 analyzes a display location of an optimum tracking start indication marker 310, 310a or 310b at which the pupil gazes (S600) based on the eye tracking information of the pupil, the display location of the tracking start indication marker 310, 310a or 310b, and the response time of the pupil measured by the measuring terminal 100, and generates a tracking start index by incorporating the results of the analysis into the tracking start index.

Furthermore, in step S600, the server 200 analyzes a display location of the optimum tracking start indication marker 310, 310a or 310b at which the pupil gazes by using the AI model.

That is, in step S600, the server 200 learns the display location of the optimum tracking start indication marker 310, 310a or 310b at which the pupil gazes on the display unit 130 by using, as learning data, the eye tracking information of the pupil and the response time of the pupil according to the location where the tracking start indication marker 310, 310a or 310b is displayed.

Furthermore, in the optimum tracking start indication marker 310, 310a or 310b, a direction toward which a gaze of a user is directed and the time when the pupil responds are different depending on the user. Accordingly, the server 200 performs normalization and analysis by learning a different location where the tracking start indication marker 310, 310a or 310b is displayed and the time and period in which the tracking start indication marker 310, 310a or 310b is displayed by using the AI model, and incorporates the results of the learning into a tracking start index.

The AI model learns the display location of the optimum tracking start indication marker 310, 310a or 310b at which the pupil gazes and the display time for which the pupil gazes at based on the learning data, including the eye tracking information of the pupil and the response time of the pupil according to the location where the tracking start indication marker 310, 310a or 310b is displayed, by using the CNN-based deep learning model.

Accordingly, reliability of the results of the analysis of a user's screen concentration level can be increased by normalizing timing at which a user's eye is tracked during a service for analyzing the screen concentration level.

Furthermore, although the preferred embodiments of the present disclosure have been described above, those skilled in the art in the art will appreciate that the present disclosure may be modified and changed in various ways without departing from the spirit and area of the present disclosure written in the claims to be described later.

Furthermore, reference numerals written in the claims of the present disclosure are merely written for the clarity of a description and for convenience' sake, and the present disclosure is not limited thereto. The thicknesses of lines or the sizes of elements illustrated in the drawings in a process of describing the embodiments may have been exaggerated for the clarity of a description and for convenience' sake.

Furthermore, the aforementioned terms have been defined by taking into consideration their functions in the present disclosure, and may be changed depending on a user or operator's intention or practice. Accordingly, such terms should be defined based on the overall contents of this specification.

Furthermore, although it is not explicitly illustrated or described, it is evident that a person having ordinary knowledge in the art to which the present disclosure pertains may modify the present disclosure in various forms including the technical spirit of the present disclosure from the writing of the present disclosure, which belongs to the scope of a right of the present disclosure.

Furthermore, the embodiments described with reference to the accompanying drawings have been described for the purpose of describing the present disclosure, and the range of a right of the present disclosure is not limited to such embodiments.

[Description of reference numerals]

| 100: measuring terminal | 110: data communication unit |
|---|---|
| 120: camera unit | 130: display unit |
| 140: terminal controller | 200: server |
| 210: data communication unit | |
| 220: content provision unit | |
| 230: pupil tracking unit | |
| 231: tracking start sensing unit | |
| 232: pupil response analysis unit | |
| 233: concentration level analysis unit | |
| 240: AI learning unit | 250: data storage unit |

300: content
310: tracking start indication marker
310a: tracking start indication marker 1
310a: tracking start indication marker n

What is claimed is:

1. An apparatus for normalizing a start of eye tracking for analyzing a user's screen concentration level, comprising:
a measuring terminal 100 configured to detect a pupil in a captured image, track a gaze of the detected pupil, and measure a response time of the pupil for which the pupil gazes at in response to a tracking start indication marker 310, 310a or 310b displayed based on a tracking start index; and
a server 200 configured to transmit content information, a tracking start index, and content information to the measuring terminal 100 and generate a tracking start index by incorporating, into the tracking start index, eye tracking information of the pupil and the response time of the pupil received from the measuring terminal 100.

2. The apparatus of claim 1, wherein the tracking start indication marker 310, 310a or 310b is displayed at any one of a specific location or a random location on a screen of the measuring terminal 100.

3. The apparatus of claim 2, wherein the server 200 normalizes and analyzes the response time of the pupil according to the location where the tracking start indication marker 310, 310a or 310b is displayed by using an artificial intelligence model and incorporates results of the normalization and analysis into the tracking start index.

4. The apparatus of claim 3, wherein the server 200 analyzes a display location of an optimum tracking start indication marker 310, 310a or 310b at which the pupil gazes by using the artificial intelligence model.

5. The apparatus of claim 1, wherein the measuring terminal 100 comprises:
a data communication unit 110 configured to transmit and receive the content information, the tracking start index, the eye tracking information of the pupil, and the response time of the pupil to and from the server 200;
a camera unit 120 configured to output the captured image including the pupil;
a display unit 130 configured to display the content information and the tracking start indication marker 310, 310a or 310b; and
a terminal controller 140 configured to detect the pupil in the captured image, obtain the eye tracking information of the detected pupil, display the tracking start indication marker 310, 310a or 310b based on the content information and the tracking start index, and measure the response time of the pupil for which the pupil gazes at in response to the tracking start indication marker 310, 310a or 310b.

6. The apparatus of claim 1, wherein the server 200 comprises:
a data communication unit 210 configured to transmit and receive the content information, the tracking start index, the eye tracking information of the pupil and the response time of the pupil to and from the measuring terminal 100;
a content provision unit 220 configured to provide given content information to the measuring terminal 100;
a pupil tracking unit 230 configured to receive the eye tracking information of the pupil and the response time of the pupil for which the pupil gazes at in response to the tracking start indication marker 310, 310a or 310b from the measuring terminal 100 and analyze the eye tracking information and the response time;
an artificial intelligence (AI) learning unit 240 configured to normalize and analyze the response time of the pupil according to a location where the tracking start indication marker 310, 310a or 310b is displayed by using an artificial intelligence model and learn calculation of a display location of an optimum tracking start indication marker 310, 310a or 310b at which the pupil gazes; and
a data storage unit 250 configured to store the content information, the tracking start index, the eye tracking information of the pupil, and the response time of the pupil.

7. The apparatus of claim 6, wherein the artificial intelligence model learns a display location of an optimum tracking start indication marker 310, 310a or 310b at which the pupil gazes based on learning data, comprising the eye tracking information of the pupil and the response time of the pupil according to a location where the tracking start indication marker 310, 310a or 310b is displayed by using a convolutional neural network (CNN)-based deep learning model.

8. The apparatus of claim 6, wherein the pupil tracking unit 230 comprises:
a tracking start sensing unit 231 configured to detect the tracking start indication marker 310, 310a or 310b; and
a pupil response analysis unit 232 configured to analyze the response time for which the pupil gazes at in response to the tracking start indication marker 310, 310a or 310b displayed based on the eye tracking information of the pupil.

9. The apparatus of claim 8, wherein the pupil tracking unit 230 further comprises a concentration level analysis unit 233 configured to analyze a concentration level by analyzing the eye tracking information of the pupil after the response time of the pupil.

10. A method of normalizing a start of eye tracking for analyzing a user's screen concentration level, comprising steps of:
a) when a server 200 authenticates login information of a measuring terminal 100, displaying given content information through the measuring terminal 100;
b) detecting, by the measuring terminal 100, a pupil in a captured image, tracking a gaze of the pupil, displaying a tracking start indication marker 310, 310a or 310b based on a tracking start index, and detecting a response of the pupil;
c) as the response of the pupil is detected, storing, by the measuring terminal 100, eye tracking information of the pupil, a display location of the tracking start indication marker 310, 310a or 310b and a response time of the pupil; and
d) analyzing, by the server 200, a display location of an optimum tracking start indication marker 310, 310a or 310b at which the pupil gazes based on the eye tracking information of the pupil, the display location of the tracking start indication marker 310, 310a or 310b, and the response time of the pupil measured by the measuring terminal 100 and generating a tracking start index by incorporating results of the analysis into the tracking start index.

11. The method of claim 10, wherein the tracking start indication marker 310, 310a or 310b in the step b is displayed at any one of a specific location or a random location on a display unit 130 of the measuring terminal 100.

12. The method of claim 10, wherein the step d) comprises analyzing, by the server 200, the display location of the optimum tracking start indication marker 310, 310a or 310b at which the pupil gazes by using an artificial intelligence model.

13. The method of claim 12, wherein the artificial intelligence model learns a display location of an optimum tracking start indication marker 310, 310a or 310b at which the pupil gazes based on learning data, comprising the eye tracking information of the pupil and the response time of the pupil according to a location where the tracking start indication marker 310, 310a or 310b is displayed by using a convolutional neural network (CNN)-based deep learning model.
